(19) United States
(12) Patent Application Publication
(10) Pub. No.: US 2024/0265329 A1
(43) Pub. Date: Aug. 8, 2024

(54) INNOVATOR CAPABILITY ASSESSMENT SYSTEM

(71) Applicant: ImproVations, Lakewood, WA (US)

(72) Inventor: David L. Fried, Lakewood, WA (US)

(73) Assignee: ImproVations, Lakewood, WA (US)

(21) Appl. No.: 18/166,299

(22) Filed: Feb. 8, 2023

(51) Int. Cl. G06Q 10/0639; G06F 16/33

(52) U.S. Cl. CPC G06Q 10/06393; G06F 16/3334

(57) ABSTRACT

An innovator capability assessment system is disclosed. The system may include a receiver configured to receive a first user response from a set of preset responses on each of a plurality of first questions from a user device. The receiver may be further configured to receive a second user response on each of a plurality of second questions from the user device. Each of the pluralities of first and second questions may be associated with one or more innovation capability traits of a plurality of innovation capability traits of a user. The system may further include a processor configured to score the first user response and the second user response, and calculate an innovation capability trait score for the user for each innovation capability trait. The system may further include a transmitter configured to transmit the innovation capability trait score to the user device.

### TECHNICAL FIELD

The present disclosure relates to an innovator capability assessment system, and more particularly, to a system that assesses a user's innovation capability by using a plurality of questionnaires and identifies improvement areas to facilitate continuous innovation.

### BACKGROUND

Continuous innovation is an integral part of strategy for most corporates and organizations. Corporates and organizations need to develop innovative products and services for their customers to remain relevant in the market and grow market share. The need for innovation has gained more prominence with the advent of Information Technology (IT). Corporates that do not innovate continuously may lose their market share to competitors or start-ups that focus on providing innovative products/services.

Most corporates have innovation as a Key Performance Indicator (KPI) for their mid-to-senior level management. While leaders understand the importance of innovation, many conventional leaders may not know how to innovate continuously that may have long-term positive impact on the work. In the absence of guidance on how to innovate, the conventional leaders tend to gravitate towards or focus on other KPIs, e.g., profitability, productivity, sales, etc. While the other KPIs may be essential for short-term stability and success, lack of focus on continuous innovation may result in long-term loss.

Conventional leadership development tools and programs focus on educating leaders the importance of continuous innovation, however the conventional tools do not assist the leaders in learning how to innovate.

Thus, there is a need in the industry for a tool that may assist leaders in identifying ways to innovate continuously.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of an example innovator capability assessment system in accordance with the present disclosure.

FIG. 3 depicts an example snapshot of one or more questions of a first set of questions in accordance with the present disclosure.

FIG. 4 depicts an example snapshot of a question from a second set of questions in accordance with the present disclosure.

FIG. 5 depicts an example snapshot of a plurality of second questions in accordance with the present disclosure.

FIG. 6 depicts an example snapshot of an innovator's capability spectrum in accordance with the present disclosure.

FIG. 7 depicts a flow diagram of an example innovator capability assessment method in accordance with the present disclosure.

### DETAILED DESCRIPTION

### Overview

The present disclosure describes an innovator capability assessment system. A user may access the system and seek inputs or guidance on innovation capability traits that the user may focus on, which may enable the user to innovate in an organization in which the user may work. The innovation capability traits may be, for example, assessing opportunity, reducing complexity, diverse collaboration, launching innovation, organizational ambidexterity and/or the like. In some aspects, the user may send an assessment request to the system via a user device, when the user seeks inputs from the system. Responsive to receiving the assessment request, the system may send a plurality of questionnaires to the user device and the user may respond to the questionnaires. The plurality of questionnaires may include questions on which the user may respond by selecting one or more preset responses and/or by adding textual responses to the questions. Further, each question included in the plurality of questionnaires may be associated or mapped with one or more innovation capability traits. Based on user's responses to the questions, the system may score the user on each innovation capability trait. The system may then transmit the score for the innovation capability traits to the user device and display the score on the user device. The user may then identify the traits in which the corresponding score is low and may focus on the identified traits to improve user's innovation creation capability.

In some aspects, the system may be configured to score individual users on each innovation capability trait to assist the users in identifying the traits on which they should focus on. In other aspects, the system may be configured to combine scores of individual users associated with an organization and may calculate an organization's score on each innovation capability trait. The organization's score may assist the organization's senior management in identifying traits that organization's employees collectively may need to focus on, e.g., by changing organization's innovation ecosystem.

The present disclosure discloses a system that assists a user (or an organization) in identifying specific innovation capability traits that the user may focus on to innovate. Specifically, the system assists the user in identifying how to innovate by providing actionable inputs on specific traits to focus on. Further, the system provides objective scores to the user on each trait so that the user may benchmark user's strength areas/traits versus areas where the user may need improvement. Furthermore, the user may use the objective scores to benchmark against other users or employees of the organization in which the user may work. In addition, the system enables the user to check user's progress on specific traits over time, which may assist the user in improving the user's innovation creation capability.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

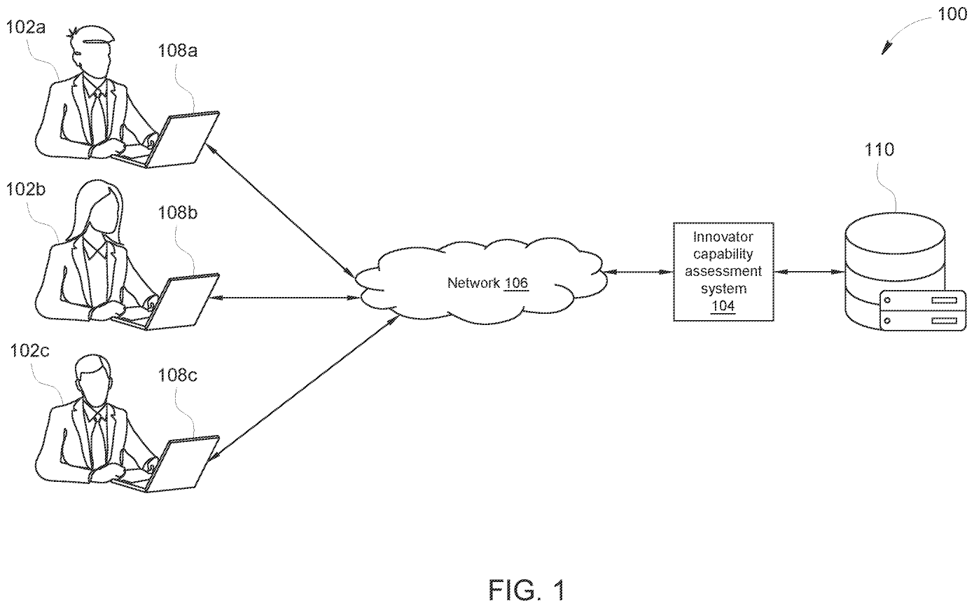

FIG. 1 depicts an example environment 100 in which techniques and structures for providing the systems and methods disclosed herein may be implemented. The environment 100 may include a plurality of users 102a, 102b, 102c (collectively referred to as a user 102) accessing an innovator capability assessment system 104 (or a system 104) via a network 106. The plurality of users 102a, 102b, 102c may access the system 104 by using respective user devices 108a, 108b, 108c (collectively referred to as a user device 108).

In some aspects, the user 102 may be a mid-to-senior level management leader in an organization. For example, the user 102 may be a General Manager (GM), a Vice President (VP), a President, a Chief Marketing Officer (CMO), a Chief Technical Officer (CTO), a Chief Operating Officer (COO), a Chief Executive Officer (CEO), a Chief Financial Officer (CFO) and the like. The user 102 may use the user device 108 to access the system 104 via the network 106. The user device 108 may be, for example, a mobile phone, a laptop, a tablet, a desktop computer or a similar device having communication capabilities.

The network 106 may be, for example, a communication infrastructure in which the connected devices discussed in various embodiments of this disclosure may communicate. The network 106 may be and/or include the Internet, a private network, public network or other configuration that operates using any one or more known communication protocols such as, for example, transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

In some aspects, the user 102 may access the system 104 to seek inputs or guidance from the system 104 on specific innovation capability traits that the user 102 may focus on to innovate continuously in the organization where the user 102 may work. Specifically, the system 104 may be configured to assess organizational and user traits/parameters and score the user 102 on a plurality of innovation capability traits based on the assessment. In some aspects, the organizational and user traits/parameters may be associated with the plurality of innovation capability traits.

Examples of organizational and user traits/parameters may include, but are not limited to, user workload, freedom to innovate or take independent decisions, user's risk taking capability, creativity, organizational impediments, presence or absence of challenging work in the organization, user and/or organization's productivity, organizational encouragement, managerial encouragement and the like. Examples of innovation capability traits may include, but are not limited to, assessing opportunities, diverse collaboration, strategic alignment, reducing complexity, launching innovation, organizational ambidexterity, evaluating innovation performance, specific innovation metrics, spin rate and the like.

As described above, the system 104 may assess the user 102 on the organizational and user traits/parameters, and may use the assessment to score the user 102 on each innovation capability trait. Based on user's score on each innovation capability trait, the system 104 may identify the specific innovation capability trait(s), from the plurality of innovation capability traits, in which the user's score may be less than a predefined threshold. The system 104 may then recommend the user 102 to focus on the identified specific innovation capability trait(s) to improve user's continuous innovation capability.

In some aspects, the system 104 may assess the user 102 on the organizational and user traits/parameters by sending a plurality of questionnaires to the user device 108. The plurality of questionnaires may relate to the user's behavioral, leadership, organizational and functional traits/parameters that in turn may relate to the plurality of innovation capability traits. Further, the plurality of questionnaires may include questions with associated preset selectable responses and/or questions for which the user 102 may provide textual responses on the user device 108. Responsive to receiving the questionnaires, the user 102 may provide responses to the questions included in the questionnaires and may send the responses to the system 104 via the user device 108. The system 104 may then analyze the responses and provide scores to the user 102 on the plurality of innovation capability traits based on the responses.

In some aspects, each question included in the questionnaires may be associated with one or more innovation capability traits. The system 104 may use a mapping of each question with the one or more innovation capability traits to score the user 102 on the plurality of innovation capability traits, based on user's responses to the questions. In one or more aspects, the mapping of each question with the innovation capability traits may be pre-stored in a system memory (not shown) or an external database 110 communicatively connected with the system 104.

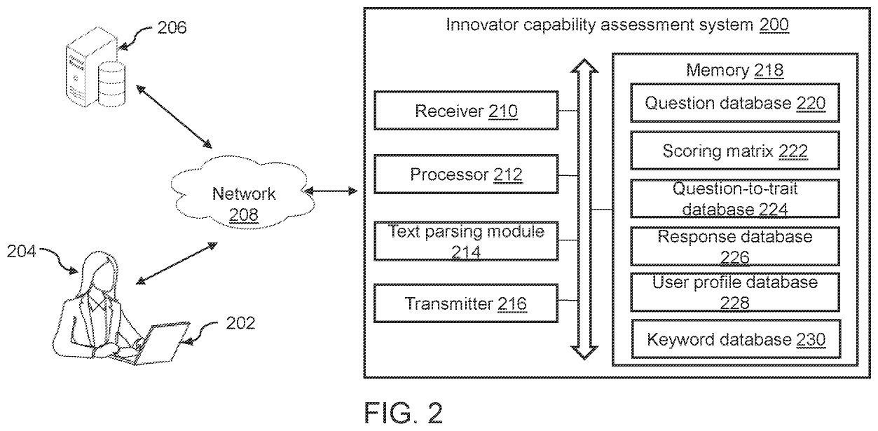

The detailed process of scoring the user 102 on the plurality of innovation capability traits is explained in detail in conjunction with FIG. 2.

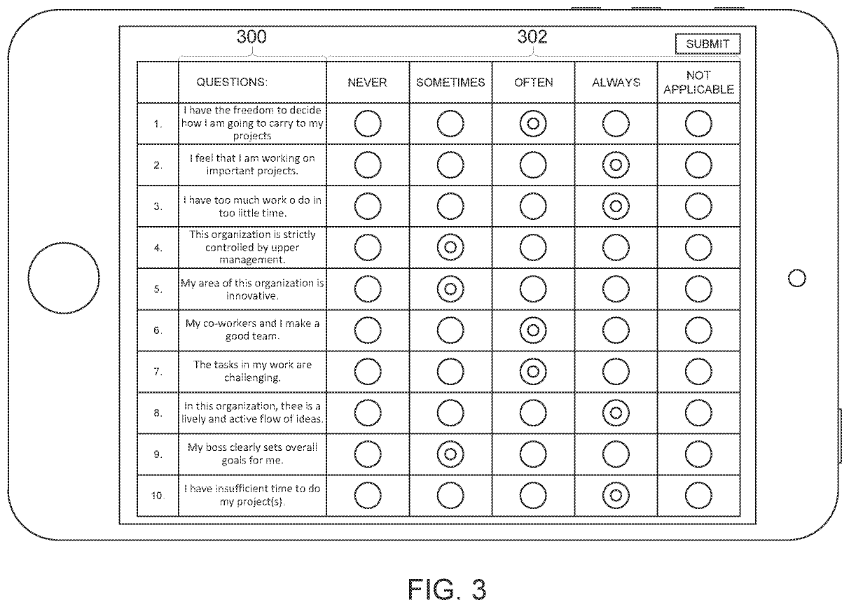

FIG. 2 depicts a block diagram of an example innovator capability assessment system 200 in accordance with the present disclosure. The innovator capability assessment system 200 (or the system 200) may be same as the system 104. In some aspects, the system 200, as described herein, can be implemented in hardware, software (e.g., firmware), or a combination thereof. While describing FIG. 2, references would be made to FIGS. 3-6.

The system 200 may be communicatively connected with a user device 202 of a user 204 and an external database 206, via a network 208. In some aspects, the user 204 and the user device 202 may be same as the user 102 and the user device 108 respectively, described in conjunction with FIG. 1. Further, the database 206 may be same as the database 110 and the network 208 may be same as the network 106. As described in conjunction with FIG. 1, the user 204 may access the system 200 via the user device 202 to seek inputs on innovation capability traits that the user 204 may focus on, which may assist the user 204 to continuously innovate in the organization in which the user 204 may work.

In some aspects, the system 200 may include a plurality of units including, but not limited to, a receiver 210, a processor 212, a text parsing module 214, a transmitter 216 and a memory 218. In some aspects, the text parsing module 214 may be part of the memory 218. In other aspects, the text parsing module 214 may be separate from the memory 218, as shown in FIG. 2. The plurality of units may communicatively couple with each other via a bus.

In some aspects, the memory 218 may store programs in code and/or store data for performing various innovator capability assessment system operations in accordance with the present disclosure. Specifically, the processor 212 may be configured and/or programmed to execute computer-executable instructions stored in the memory 218 for performing various innovator capability assessment system functions in accordance with the disclosure. Consequently, the memory 218 may be used for storing code and/or data code and/or data for performing operations in accordance with the present disclosure.

In one or more aspects, the processor 212 may be disposed in communication with one or more memory devices (e.g., the memory 218 and/or one or more external databases (e.g., the database 206)). The memory 218 can include any one or a combination of volatile memory elements (e.g., dynamic random-access memory (DRAM), synchronous dynamic random access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.).

The memory 218 may be one example of a non-transitory computer-readable medium and may be used to store programs in code and/or to store data for performing various operations in accordance with the disclosure. The instructions in the memory 218 can include one or more separate programs, each of which can include an ordered listing of computer-executable instructions for implementing logical functions.

In further aspects, the memory 218 may include a plurality of databases including, but not limited to, a question database 220, a scoring matrix 222, a question-to-trait database 224, a response database 226, a user profile database 228 and a keyword database 230. The processor 212 may be configured to access the plurality of databases to perform the innovator capability assessment system operations in accordance with the present disclosure.

In operation, the user 204 may access the system 200 via the user device 202 to seek inputs on innovation capability traits that the user 204 may focus on, as described above. Specifically, to access the system 200, the user 204 may create a user profile on the system 200 when the user 204 accesses the system 200 for the first time. For example, the user 204 may send user information and/or user's organization information to the receiver 210, which may then send the received information to the user profile database 228 for storage purpose. The user information may include, for example, user name, office address, designation, total years of experience, years of employment in the organization, details of projects managed by the user 204, a number of team members in user's team, area of expertise, details of roles and responsibilities and/or the like. The user's organization information may include organization's gross revenue, a number of employees in the organization, a number of members in senior management team, a count of innovations introduced to the market by the organization in the past three/five/seven years (innovation count), gross revenue made from the sale of the innovations (innovation revenue) and/or the like. In some aspects, the system 200 may transmit (via the transmitter 216) a confidentiality agreement/contract to the user device 202, before or when the user 204 sends the user information and/or user's organization information to the receiver 210.

The system 200 may create the user profile for the user 204 when the receiver 210 receives the user information and/or the user's organization information from the user device 202 (and when the user profile database 228 stores the received information). The user 204 may access the system 200 when the system 200 creates the user profile.

To access and seek inputs on innovation capability traits from the system 200, the user 204 may send (via the network 208) an assessment request to the receiver 210 by using the user device 202. Responsive to receiving the assessment request, the receiver 210 may send the assessment request to the processor 212. The processor 212 may send a command to the question database 220 to fetch a plurality of first questions, when the processor 212 receives the assessment request from the receiver 210.

In some aspects, the question database 220 may pre-store the plurality of first questions and may send the plurality of first questions to the processor 212, responsive to receiving the command from the processor 212. In one or more aspects, the plurality of first questions may include a first set of questions and a second set of questions.

The first set of questions may include questions indicative of user organization's readiness for continuous innovation or user's inclination towards innovation. Specifically, the first set of questions may be segregated based on user or organizational traits, parameters or sections (hereinafter referred to as organizational parameters) indicating a presence or absence of organization's ecosystem for continuous innovation or the user's inclination towards continuous innovation. For example, the first set of questions may include a preset number of questions (e.g., in the range of 60-100), which may be segregated into sections such as freedom (for independent decision-making), challenging work, creativity, workload pressure, managerial encouragement, organizational encouragement, productivity, work group support, sufficient resources and/or the like. A first set of questions' mapping with respective organizational parameters may be pre-stored in the question-to-trait database 224.

Further, each organizational parameter may be associated or mapped with one or more innovation capability traits/categories. As described in FIG. 1, the innovation capability traits/categories may be, for example, assessing opportunities, diverse collaboration, strategic alignment, reducing complexity, launching innovation, organizational ambidexterity, evaluating innovation performance, specific innovation metrics, spin rate and the like. As an example, the organizational parameter of “freedom” may be associated with innovation capability traits “reducing complexity” and “organizational ambidexterity”. Similarly, the organizational parameter of “productivity” may be associated with innovation capability traits “strategic alignment”, “organizational ambidexterity” and “launching innovation”. In some aspects, an organizational parameter mapping with respective one or more innovation capability traits may also be pre-stored in the question-to-trait database 224.

A person ordinarily skilled in the art may appreciate from the description above that each question in the first set of questions may be associated with an organizational parameter and each user/organizational parameter may be associated with one or more innovation capability traits. Therefore, each question in the first set of questions may relate to or be associated with one or more innovation capability traits.

Furthermore, in an exemplary embodiment, the first set of questions may include 78 questions and each question may include a set of preset responses. An example of the first set of questions is shown in FIG. 3. Specifically, FIG. 3 depicts an example snapshot of one or more questions 300 of the first set of questions in accordance with the present disclosure. Each question 300 may relate to an organizational parameter (not shown) and may include a set of five selectable responses 302. For example, the question “I have the freedom to decide how I am going to carry out my projects” may relate to “freedom” parameter, the question “I feel that I am working on important projects.” may relate to “challenging work” parameter, the question “I believe that I am currently very creative in my work” may relate to “creativity” parameter and the like. Further, each question may have associated selectable responses 302 such as “Never”, “Sometimes”, “Often”, “Always” and “Not Applicable”. In some aspects, for each question included in the first set of questions, a user (e.g., the user 204) may be able to select only one response. In other words, multiple responses to the same question may not be enabled for the first set of questions.

Although the responses 302 are shown as five in number, a person ordinarily skilled in the art may appreciate that more or less number of preset responses may be included in the responses 302. Further, the questions 300 and the responses 302 are shown as examples and should not be construed as limiting the present disclose scope.

In additional aspects, each response 302 may be associated with a preset response score. For example, the response “Never” may have an associated response score of zero, the response “Sometimes” may have a score of one, the response “Often” may have a score of two, the response “Always” may have a score of three and the response “Not Applicable” may have a score of zero. In one or more aspects, a response mapping with respective preset scores may be pre-stored in the scoring matrix 222.

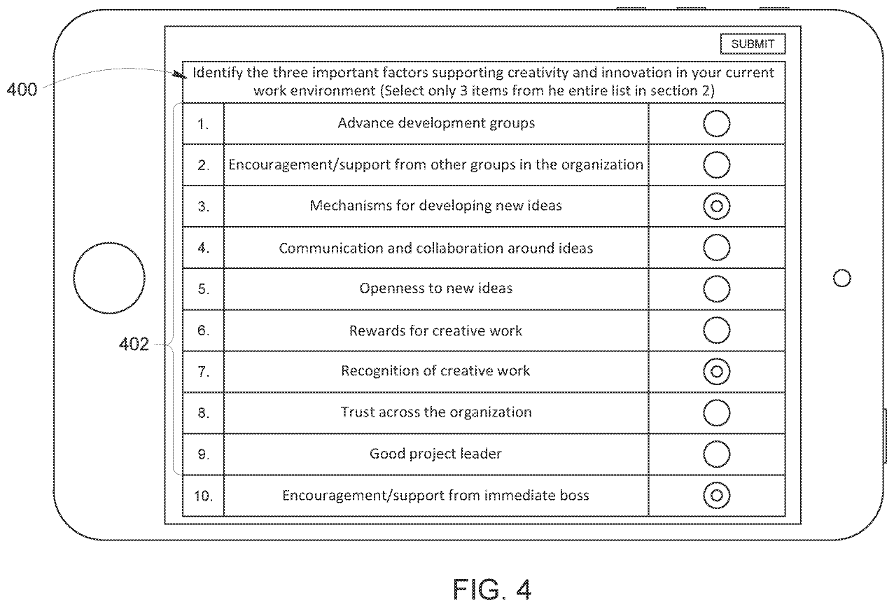

In further aspects, the second set of questions may also include questions indicative of the user organization's readiness for continuous innovation, however the second set of questions may include questions that may enable a user (e.g., the user 204) to select three (or a predefined number of) preset responses for a single question. An example of the second set of questions is shown in FIG. 4. Specifically, FIG. 4 depicts an example snapshot of a question 400 from the second set of questions in accordance with the present disclosure. The question 400 may have a plurality of associated responses 402 and the user (e.g., the user 204) may select any three (or the predefined number of) responses from the plurality of associated responses 402.

In some aspects, each response 402 may be associated or mapped with one or more innovation capability traits. For example, the response “communication and collaboration around ideas” may be mapped to innovation capability traits “diverse collaboration” and “strategic alignment”. In some aspects, a response mapping with respective innovation capability traits may be pre-stored in the question-to-trait database 224.

Responsive to receiving the plurality of first questions (which includes the first and the second sets of questions described above) from the question database 220, the processor 212 may send the plurality of first questions to the transmitter 216. The transmitter 216 may then transmit the plurality of first questions to the user device 202, via the network 208, for the user device 202 to display the plurality of first questions for the user 204.

Responsive to receiving the plurality of first questions on the user device 202, the user 204 may respond to each question. For example, the user 204 may select a preset response from the responses 302 for each question included in the first set of questions and may select three responses from the responses 402 for each question included in the second set of questions. The user 204 may submit the responses on the user device 202, when the user 204 answers all the questions included in the first and the second sets of questions. Responsive to the user 204 submitting the responses, the user device 202 may transmit the responses to the receiver 210, via the network 208.

The receiver 210 may send the responses to the response database 226 for storage purpose, when the receiver 210 receives the responses from the user device 202. In addition, the receiver 210 may send the responses to the processor 212 for analysis. In an alternative aspect, the processor 212 may fetch the responses from the response database 226 for analysis.

Responsive to receiving the responses, the processor 212 may determine a score for each response submitted by the user 204. Specifically, for each response for the first set of questions, the processor 212 may determine whether the user 204 has selected “Never”, “Sometimes”, “Often”, “Always” or “Not Applicable”. The processor 212 may then fetch preset response scores for each response from the scoring matrix 222 and determine the corresponding score for the response. For example, if the user 204 selects “Often” for the question “I have the freedom to decide how I am going to carry out my projects”, the processor 212 may determine the score for the response “Often” as two from the scoring matrix 222. Similarly, the processor 212 may determine scores for each response to the first set of questions provided by the user 204.

Furthermore, the processor 212 may combine scores of all responses corresponding to all the questions associated with an organizational parameter and calculate a first score for the organizational parameter. For example, the processor 212 may sum scores for all responses corresponding to questions associated with the “freedom” organizational parameter, to calculate the first score for the “freedom” organizational parameter. In some aspects, the processor 212 may fetch the first set of question's mapping with the respective organizational parameters from the question-to-trait database 224, before calculating the scores for each organizational parameter. As an example, the processor 212 may determine the specific questions from the first set of questions that are associated with the “freedom” organizational parameter from the mapping and then calculate the first score for the “freedom” organizational parameter.

In some aspects, the processor 212 may calculate the first score for each organizational parameter by performing a linear sum of individual response scores. In other aspects, the processor 212 may calculate the first score by performing weighted sum of individual response scores. For example, the system 200 may assign a higher weight to one or more questions of a set of questions associated with the “freedom” organizational parameter. In this case, the processor 212 may calculate the first score based on the weights of each question of the first set of questions. In some aspects, the weights assigned to each question may be stored in the scoring matrix 222 and the processor 212 may first fetch the weights from the scoring matrix 222 before calculating the first score for each organizational parameter.

Responsive to calculating the first score for each organizational parameter, the processor 212 may calculate a second score for each innovation capability trait. Specifically, as described above, each organizational parameter may be associated or mapped with one or more innovation capability traits, and the organizational parameter mapping with the corresponding one or more innovation capability traits may be pre-stored in the question-to-trait database 224. Responsive to calculating the first score for each organizational parameter, the processor 212 may fetch the organizational parameter mapping with the innovation capability traits from the question-to-trait database 224 and determine the organizational parameters associated with each innovation capability trait. For example, the processor 212 may determine that the “organizational ambidexterity” innovation capability trait may be associated with “freedom” and “productivity” organizational parameters. Thereafter, the processor 212 may calculate the second score for “organizational ambidexterity” by summing the first scores of “freedom” and “productivity” organizational parameters. Similarly, the processor 212 may calculate second scores for each innovation capability trait.

In some aspects, the processor 212 may calculate the second score for an innovation capability trait (e.g., organizational ambidexterity) by performing a linear sum of first scores for the associated organizational parameters (e.g., freedom and productivity). In other aspects, the processor 212 may calculate the second score by performing a weighted sum of first scores for the associated organizational parameters. For example, the system 200 may assign a higher weight to the freedom parameter than the productivity parameter. In this case, the processor 212 may calculate the second score based on the weights assigned to each organizational parameter by the system 200. In some aspects, the weights assigned to each organizational parameter may be pre-stored in the scoring matrix 222 and the processor 212 may first fetch the weights from the scoring matrix 222 before calculating the second score for each innovation capability trait.

In further aspects, for each question from the second set of questions, the processor 212 may determine the selections (e.g., three selections) submitted by the user 204. For example, for the question 400, the processor 212 may determine the three selections/responses submitted by the user 204. Further, the processor 212 may determine an order of selection made by the user 204, while submitting the selections. For example, the processor 212 may determine that the user 204 selected the response “advance development groups” first, followed by “openness to new ideas” and selected “rewards for creative work” at the last. In some aspects, the user device 202 may send the user's order of selection to the receiver 210, which in turn may send the order to the processor 212.

Responsive to determining the order, the processor 212 may fetch a preset order score from the scoring matrix 222 and determine a third score for the selections submitted by the user 204. In some aspects, the preset order score may indicate scores for the responses that the user 204 selects first, followed by the second selection and the third selection. As an example, the preset order score may indicate a score of five for the first selection, a score of three for the second selection and a score of one for the third selection. Therefore, in the example described above, the third scores for the responses “advance development groups”, “openness to new ideas” and “rewards for creative work” may be five, three and one respectively.

Responsive to determining the third scores, the processor 212 may determine one or more innovation capability traits associated with the responses selected by the user 204 by fetching the response mapping with innovation capability traits from the question-to-trait database 224. Specifically, as described above, each response 402 may be associated or mapped with one or more innovation capability traits and the response mapping with innovation capability traits may be stored in the question-to-trait database 224. The processor 212 may fetch the mapping and determine the one or more innovation capability traits that may be associated with the responses selected by the user 204.

Responsive to determining the one or more innovation capability traits, the processor 212 may calculate a fourth score for the innovation capability traits. For example, if “advance development groups” response maps to innovation capability traits “strategic alignment” and “diverse collaboration”, the processor 212 may calculate a fourth score of five for the innovation capability traits “strategic alignment” and “diverse collaboration”. Similarly, the processor 212 may determine fourth scores for one or more innovation capability traits based on the responses to the second set of questions submitted by the user 204.

Responsive to calculating the second score and the fourth score for the innovation capability traits, the processor 212 may calculate a fifth score for each innovation capability trait. In some aspects, the fifth score may be a linear average or a weighted average of the second score and the fourth score.

Responsive to calculating the fifth score for each innovation capability trait or responsive to receiving the responses to the plurality of first questions (e.g., the first set of questions and the second set of questions) from the user device 202, the processor 212 may fetch a plurality of second questions from the question database 220.

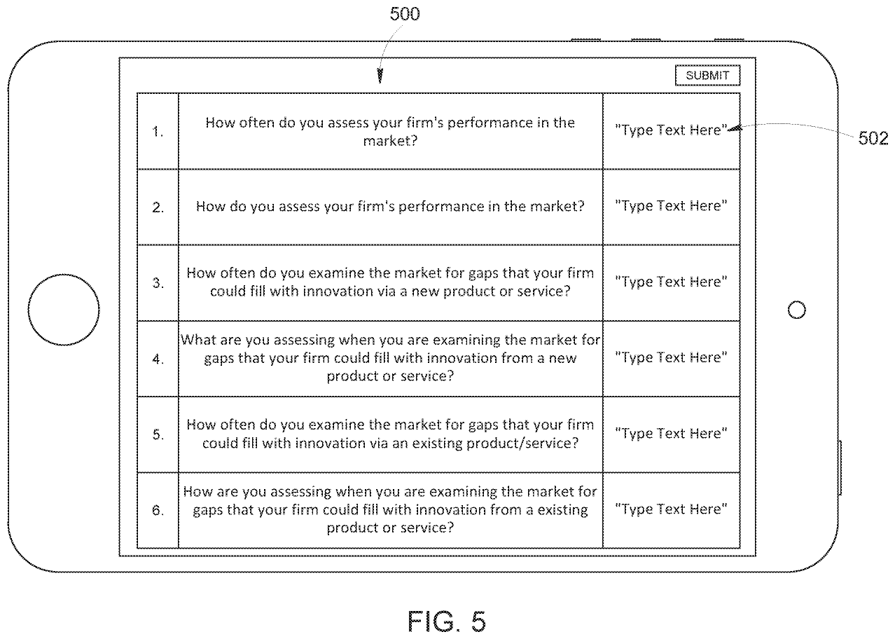

The plurality of second questions may be similar to the plurality of first questions, however the plurality of second questions may relate to how the user 204 or the user's organization innovates, how often user/organization innovate, how user/organization measure success of innovation and other similar questions. In some aspects, each second question may be associated with one or more innovation capability traits. Further, to respond to the plurality of second questions, a user (e.g., the user 204) may add textual or qualitative responses. Examples of second questions are shown in FIG. 5. Specifically, FIG. 5 depicts an example snapshot of a plurality of second questions 500 in accordance with the present disclosure. As shown in FIG. 5, the user (e.g., the user 204) may add textual responses 502 for each second question 500.

In an exemplary embodiment, the question “How often do you examine the market for gaps that your firm could fill with innovation via a new product or service?” may be associated with the innovation capability trait “Assessing opportunity”, the question “How do you assess your firm's performance in the market?” may be associated with innovation capability traits “Assessing opportunity” and “Evaluating Innovation Performance”, and the like. In some aspects, a second question mapping with one or more innovation capability traits may be pre-stored in the question-to-trait database 224.

Responsive to fetching the plurality of second questions 500 from the question database 220, the processor 212 may send the plurality of second questions 500 to the transmitter 216. The transmitter 216 may then transmit the plurality of second questions 500 to the user device 202. The user 204 may add textual or qualitative responses to the plurality of second questions 500 and may submit the responses.

The receiver 210 may receive the responses to the plurality of second questions 500 when the user 204 submits the responses. Responsive to receiving the responses, the receiver 210 may send the responses to the response database 226 for storage purpose and to the processor 212 for analysis.

Responsive to receiving the responses, the processor 212 may fetch a plurality of pre-stored comparative keywords for each second question 500 from the keyword database 230. Specifically, the keyword database may include the plurality of pre-stored comparative keywords or phrases for each second question 500. The pre-stored comparative keywords or phrases may indicate possible or probable responses from a user (e.g., the user 204) on each second question 500. For example, comparative keywords corresponding to the question “How often do you assess your firm's performance in the market?” may include keywords such as “Daily”, “Weekly”, “Monthly”, “Quarterly”, “Annually”, “Never” and the like. Similarly, comparative keywords or phrases for the question “How do you assess your firm's performance in the market?” may include keywords/phrases such as “Competitors' products”, “Revenue”, “Share price”, “Customer satisfaction”, “Innovation”, “Growth” and the like.

In further aspects, each comparative keyword or phrase associated with each second question 500 may have an associated score. For example, the keywords “Daily”, “Weekly”, “Monthly”, “Quarterly”, “Annually”, “Never” may have associated scores of five, four, three, two, one and zero respectively. In some aspect, a keyword mapping with associated score may be pre-stored in the scoring matrix 222.

Responsive to receiving the plurality of pre-stored comparative keywords/phrases for each second question 500 from the keyword database 230, the processor 212 may command the text parsing module 214 to parse responses submitted by the user 204 for each second question 500. The text parsing module 214 may parse the textual responses for each second question 500, when the text parsing module 214 receives the command from the processor 212.

In some aspects, the text parsing module 214 may run a neural network model (not shown) and create a word cloud for each textual response, when the text parsing module 214 parses the response. In one or more aspects, the word cloud may include the keywords used by the user 204 in the response to each second question 500 and a count of each keyword.

In some aspects, the text parsing module 214 may run the neural network model to ascertain similarity in keywords included in each response and may accordingly create the word cloud by combining or replacing similar keywords. For example, the user 204 may mention “Once a week”, “Every Monday” or “Once every seven days”, as opposed to “Weekly” in the response to the second question 500. The text parsing module 214 may run the neural network model to combine or replace such similar keywords or phrases and consolidate them under a single keyword “Weekly”. In some aspects, the text parsing module 214 may use a keyword ontology (not shown) to perform the combination/replacement as described above and create the word cloud for each response. In some aspects, the keyword ontology may be pre-stored in the memory 218 or the database 206. In this case, the text parsing module 214 may first fetch the keyword ontology from the memory 218 or the database 206 and then run the neural network model to create the word cloud for each response.

In one or more aspects, the neural network model described above may be a trained or unsupervised neural network model that may analyze the responses for each second question 500 and create the word cloud by combining/replacing similar keywords. Examples of the neural network model may include, but are not limited to, a deep neural network (DNN), a convolutional neural network (CNN), a recurrent neural network (RNN), a CNN-recurrent neural network (CNN-RNN), R-CNN, Fast R-CNN, Faster R-CNN, an artificial neural network (ANN), a Long Short Term Memory (LSTM) network based RNN, CNN+ANN, LSTM+ANN, a gated recurrent unit (GRU)-based RNN, a fully connected neural network, a deep Bayesian neural network, a Generative Adversarial Network (GAN), and/or a combination of such networks. In some aspects, the neural network model may include numerical computation techniques using data flow graphs. In one or more aspects, the neural network model may be based on a hybrid architecture of multiple Deep Neural Networks (DNNs).

Responsive to creating the word cloud for each response, the text parsing module 214 may send the word cloud to the processor 212. The processor 212 may then calculate a sixth score for each question 500, based on the word cloud. Specifically, the processor 212 may compare the keywords present in the response for a specific second question 500 with the comparative pre-stored keywords/phrases fetched from the keyword database 230 for the second question 500 and calculate the sixth score for the second question 500. For example, the processor 212 may determine from the word cloud whether the user 204 has used the keyword “Daily”, “Weekly”, “Monthly”, “Quarterly”, “Annually” or “Never” in response to the question “How often do you assess your firm's performance in the market?”. If the processor 212 determines that the user 204 has used the keyword “Weekly”, the processor 212 may calculate a score of four for this specific second question 500, by identifying the score for the keyword “Weekly” from the scoring matrix 222. In this case, the processor 212 may first fetch the keyword mapping with associated score from the scoring matrix 222 and then calculate the sixth score for the second question 500.

In some aspects, the processor 212 may calculate the sixth score for the second question 500 by determining presence of specific keywords (or type of keywords) in the response, as described above. In other aspects, the processor 212 may calculate the sixth score for the second question 500 based on a count of a specific keyword in the response. For example, in an exemplary embodiment, the processor 212 may calculate the sixth score for the question “How do you assess your firm's performance in the market?” based on a keyword count for the keyword “Innovation” (or similar keywords) in the response. For example, if the user 204 uses the keyword “Innovation” multiple times, the sixth score for the question may be higher. In some aspects, the processor 212 may identify the keyword count from the word cloud provided by the text parsing module 214. In further aspects, a scoring rule for each second question 500 based on keyword count may be pre-stored in the scoring matrix 222 and the processor 212 may first fetch the scoring rule from the scoring matrix 222 before calculating the sixth score for each second question 500.

Responsive to calculating the sixth score for each second question 500, the processor 212 may calculate a seventh score for each innovation capability trait. Specifically, as described above, each second question 500 may be associated with one or more innovation capability traits and the second question mapping with the innovation capability traits may be pre-stored in the question-to-trait database 224. The processor 212 may identify the associated innovation capability trait(s) for each second question 500 by fetching the mapping from the question-to-trait database 224. Thereafter, the processor 212 may sum the sixth scores of all second questions 500 that are associated with a particular innovation capability trait (e.g., “Assessing opportunity”) to calculate the seventh score for the innovation capability trait “Assessing opportunity”. In some aspects, the processor 212 may perform a linear sum or a weighted sum of sixth scores to calculate the seventh score for each innovation capability trait.

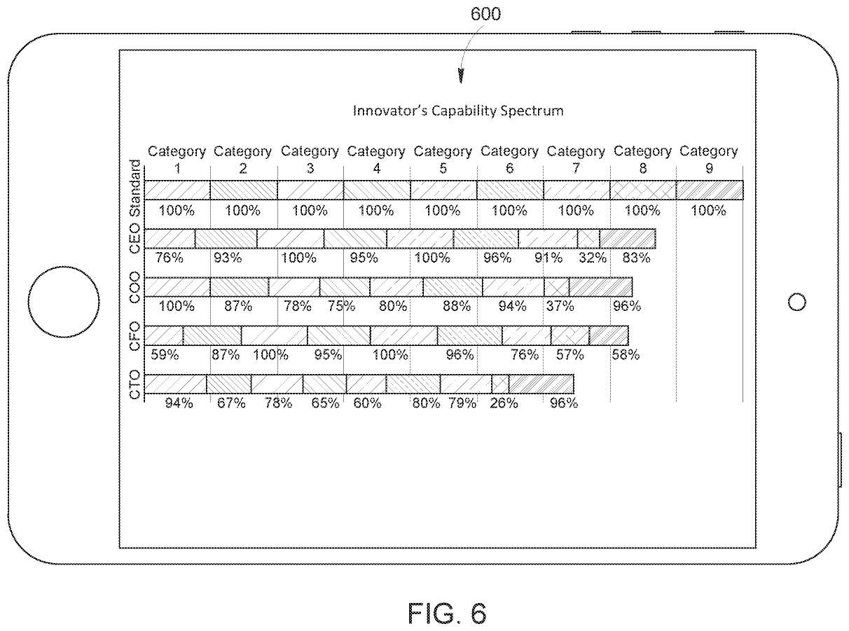

Responsive to calculating the seventh score for each innovation capability trait, the processor 212 may calculate a final score for each innovation capability trait. The final score for each innovation capability trait may be an average (linear or weighted) of the fifth score and the seventh score. An example of the final score for each innovation capability trait is shown in FIG. 6. Specifically, FIG. 6 depicts an example snapshot of an innovator's capability spectrum 600 in accordance with the present disclosure.

As shown in FIG. 6, the system 200 may assess different users (shown as CEO, COO, CFO, CTO) of an organization as described above, and the processor 212 may calculate final scores for each user on each innovation capability trait (shown as Categories 1-9). In an exemplary embodiment, the categories 1-9 may include categories “Assessing Opportunity”, “Diverse Opportunity”, “Strategic Alignment”, “Reducing Complexity”, “Launching Innovation”, “Organizational Ambidexterity”, “Evaluating Innovation Performance”, “Specific Innovation Metrics” and “Spin rate”. “Standard”, as shown in FIG. 6, may indicate the maximum score in percentage that a user can score in the corresponding innovation capability trait. In some aspects, a final score on an innovation capability trait for a user (e.g., the user 204) may be shown as a percentage of the maximum score that can be scored for the innovation capability trait. For example, a score of 76% for Category 1 for the CEO may indicate that the CEO's score is 76% of the maximum score that may be scored for Category 1.

Responsive to calculating the final scores, the processor 212 may transmit, via the transmitter 216, the view as shown in FIG. 6 to the corresponding users (specifically to users' devices). For example, if the user 204 is the CEO, the processor 212 may transmit the CEO scores to the user device 202 for display. The user 204 may identify traits on which the user 204 may focus on for continuous innovation, based on the score on each innovation capability trait that the user device 202 displays. For example, as shown in FIG. 6, the user 204 may have a low score (e.g., 32%) on Category 8, which may be “Specific Innovation Metrics”. The user 204 may focus on “Specific Innovation Metrics” (e.g., by focusing more on innovation details and defining clear success metrics) to improve the user's capability for continuous innovation.

In some aspects, the processor 212 may transmit the final scores for all innovation capability traits to the user 204, as described above. In other aspects, the processor 212 may compare the user's score on each innovation capability trait with a predefined threshold and may transmit scores for only those innovation capability traits for which the corresponding scores are lower than the predefined threshold. In this case, the user 204 may get concise inputs or recommendations on the innovation capability trait(s) that the user 204 may focus on.

In additional aspects, the processor 212 may transmit best practice recommendations to the user device 202, corresponding to the innovation capability trait(s) for which the user 204 may have a low score (e.g., score less than the predefined threshold). In this case, the best practice recommendations may include guidelines, instructions or case studies that the user 204 may view on a user device display and may implement the instructions to improve the user's continuous innovation capability. In some aspects, the best practice recommendations corresponding to each innovation capability trait may be pre-stored in the memory 218 and the processor 212 may first fetch the best practice recommendations corresponding to the innovation capability trait with low user score from the memory 218, before transmitting the best practice recommendations to the user device 202. In an exemplary aspect, the memory 218 may pre-store customized best practice recommendations based on organization type, industry type, user designation and/or the like.

In further aspects, the processor 212 may average final scores of all senior members of an organization and may calculate a final score for the organization corresponding to each innovation capability trait. For example, the processor 212 may average scores of CEO, COO, CFO, CTO and CMO, and calculate the organization's final scores. In this case, the user 204 may identify specific innovation capability trait(s) on which the organization may focus on to continuously innovate.

In additional aspects, the processor 212 may send the final score (and the remaining scores described above, e.g., first to seventh) to the memory 218 for storage purpose. Thereafter, the processor 212 may perform a comparative analysis of user or organization scores when the user(s) accesses the system 200 again for a second assessment after a predefined time. For example, if the user 204 accesses the system 200 after six months of receiving the final scores as mentioned above and the system 200 performs the user assessment again, the system 200 may share the new final scores and old final scores with the user 204 for comparative purpose. In this manner, the user 204 may determine whether the user 204 has improved on specific innovation capability traits.

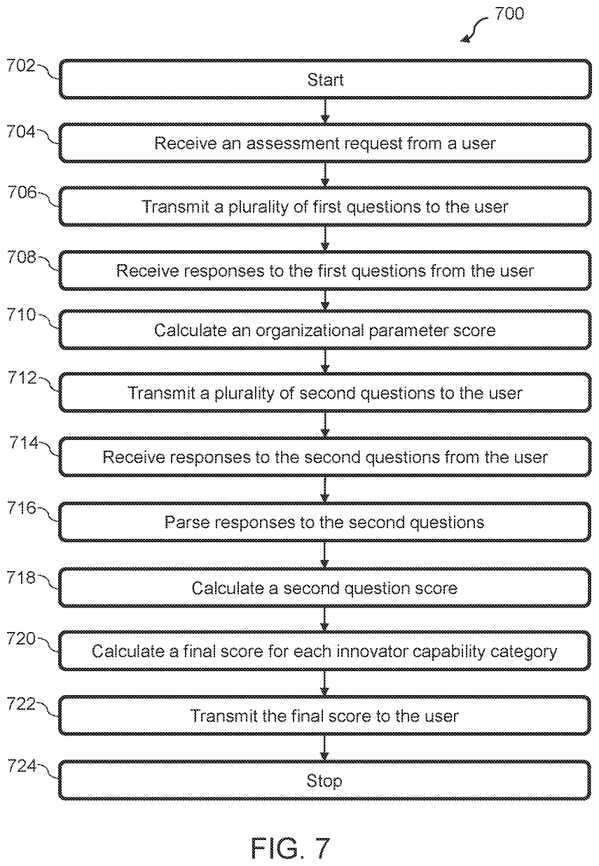

FIG. 7 depicts a flow diagram of an example innovator capability assessment method 700 in accordance with the present disclosure. FIG. 7 may be described with continued reference to prior figures. The following process is exemplary and not confined to the steps described hereafter. Moreover, alternative embodiments may include more or less steps that are shown or described herein and may include these steps in a different order than the order described in the following example embodiments.

Referring to FIG. 7, at step 702, the method 700 may commence. At step 704, the method 700 may include receiving, by the receiver 210, an assessment request from a user (e.g., the user 204) via the user device 202. As described above, the user 204 may send the assessment request (via the user device 202) to the receiver 210 to seek inputs on innovation capability traits from the system 200. Responsive to receiving the assessment request, at step 706, the method 700 may include transmitting, by the transmitter 216, the plurality of first questions to the user device 202 associated with the user 204.

Responsive to receiving the plurality of first questions, the user 204 may respond to the questions on the user device 202 and send the responses to the receiver 210. At step 708, the method 700 may include receiving, by the receiver 210, the responses to the plurality of first questions from the user 204. At step 710, the method 700 may include calculating, by the processor 212, an organizational parameter score for each organizational parameter associated with the plurality of first questions. The organizational parameter score, as mentioned here, may be same as the first score for the organizational parameter as described in conjunction with FIG. 2.

At step 712, the method 700 may include transmitting, by the transmitter 216, a plurality of second questions to the user 204, specifically to the user device 202. At step 714, the method 700 may include receiving, by the receiver 210, the responses to the plurality of second questions from the user 204 via the user device 202. At step 716, the method 700 may include parsing, by the text parsing module 214, the responses to the plurality of second questions. As described in conjunction with FIG. 2, the text parsing module 214 may create word cloud for the responses to the plurality of second questions based on the parsing and may share the word cloud with the processor 212.

Responsive to receiving the word cloud from the text parsing module 214, at step 718, the method 700 may include calculating, by the processor 212, a second question score for each second question. In some aspects, the second question score as mentioned here may be same as the sixth score described in conjunction with FIG. 2.

At step 720, the method 700 may include calculating, by the processor 212, a final score for each innovator capability category/trait based on the organizational parameter score and the second question score. The process of calculating the final score for each innovator capability trait is described in conjunction with FIG. 2. At step 722, the method 700 may include transmitting, by the transmitter 216, the final score to the user 204 (specifically to the user device 202).

At step 724, the method 700 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. An innovator capability assessment method comprising:
obtaining, by a processor, a first user response on each of a plurality of first questions, wherein:
the plurality of first questions is associated with a plurality of innovator capability categories, and
the first user response is selected from a plurality of preset responses;
determining, by the processor, a first score for each first user response;
obtaining, by the processor, a second user response on each of a plurality of second questions, wherein:
the plurality of second questions is associated with the plurality of innovator capability categories, and
the second user response comprises a qualitative response to each second question;
determining, by the processor, a presence of at least one predefined keyword in the qualitative response;
calculating, by the processor, a second score for each second question based on the presence of the at least one predefined keyword;
calculating, by the processor, a third score for each innovator capability category based on the first score and the second score; and
transmitting, by the processor, the third score to a user device.

2. The innovator capability assessment method of claim 1 further transmitting the plurality of first questions and the plurality of second questions to the user device and receiving the first user response and the second user response from the user device in response to transmitting the plurality of first questions and the plurality of second questions.

3. The innovator capability assessment method of claim 2, wherein the plurality of second questions is transmitted when the first user response is received from the user device on each first question.

4. The innovator capability assessment method of claim 1, wherein the plurality of first questions is associated with a set of organizational and user parameters, and wherein each user and organizational parameter is associated with at least one innovator capability category of the plurality of innovator capability categories.

5. The innovator capability assessment method of claim 1 further comprising:
comparing the third score with a predefined threshold score; and
transmitting the third score to the user device based on the comparison.

6. The innovator capability assessment method of claim 1 further comprising determining a count of the at least one predefined keyword in the qualitative response.

7. The innovator capability assessment method of claim 6, wherein the second score is calculated based on the count.

8. The innovator capability assessment method of claim 1 further comprising:
determining a type of the at least one predefined keyword in the qualitative response; and
comparing the type with a plurality of predefined keyword types.

9. The innovator capability assessment method of claim 8, wherein the second score is calculated based on the comparison.

10. The innovator capability assessment method of claim 1, wherein the third score is an average of the first score and the second score.

11. The innovator capability assessment method of claim 1 further comprising storing the first user response, the second user response, the first score, the second score and the third score in a memory.

12. An innovator capability assessment system comprising:
a receiver configured to:
receive a first user response on each of a plurality of first questions, wherein:
the plurality of first questions is associated with a plurality of innovator capability categories, and
the first user response is selected from a plurality of preset responses;
receive a second user response on each of a plurality of second questions, wherein:
the plurality of second questions is associated with the plurality of innovator capability categories, and
the second user response comprises a qualitative response to each second question;
a processor communicatively coupled to the receiver;
a memory for storing executable instructions, the processor configured to execute the instructions to:
obtain the first user response and the second user response from the receiver;
determine a first score for each first user response;
determine a presence of at least one predefined keyword in the qualitative response;
calculate a second score for each second question based on the presence of the at least one predefined keyword; and
calculate a third score for each innovator capability category based on the first score and the second score; and
a transmitter configured to transmit the third score to a user device.

13. The innovator capability assessment system of claim 12, wherein the transmitter is further configured to transmit the plurality of first questions and the plurality of second questions to the user device and the receiver is further configured to receive the first user response and the second user response from the user device in response to transmitting the plurality of first questions and the plurality of second questions.

14. The innovator capability assessment system of claim 13, wherein the transmitter transmits the plurality of second questions when the receiver receives the first user response from the user device on each first question.

15. The innovator capability assessment system of claim 12, wherein the plurality of first questions is associated with a set of organizational parameters, and wherein each organizational parameter is associated with at least one innovator capability category of the plurality of innovator capability categories.

16. The innovator capability assessment system of claim 12, wherein the processor is further configured to compare the third score with a predefined threshold score and the transmitter is configured to transmit the third score to the user device based on the comparison.

17. The innovator capability assessment system of claim 12, wherein the processor is further configured to determine a count of the at least one predefined keyword in the qualitative response.

18. The innovator capability assessment system of claim 17, wherein the processor calculates the second score based on the count.

19. The innovator capability assessment system of claim 12, wherein the third score is an average of the first score and the second score.

20. A non-transitory computer-readable storage medium in a distributed computing system, the non-transitory computer-readable storage medium having instructions stored thereupon which, when executed by a processor, cause the processor to:
obtain a first user response on each of a plurality of first questions, wherein:
the plurality of first questions is associated with a plurality of innovator capability categories, and
the first user response is selected from a plurality of preset responses;
determine a first score for each first user response;
obtain a second user response on each of a plurality of second questions, wherein:
the plurality of second questions is associated with the plurality of innovator capability categories, and
the second user response comprises a qualitative response to each second question;
determine a presence of at least one predefined keyword in the qualitative response;
calculate a second score for each second question based on the presence of the at least one predefined keyword;
calculate a third score for each innovator capability category based on the first score and the second score; and
transmit the third score to a user device.
